(19) United States
(12) Patent Application Publication
(10) Pub. No.: US 2024/0180365 A1
(43) Pub. Date: Jun. 6, 2024

(54) KAMADO AND METAL KETTLE ROTISSERIE ADAPTER

(71) Applicant: Linwood Resources, LLC, St. Paul, MN (US)

(72) Inventors: David R. Cleveland, Big Sky, MT (US); David O. Sewall, St. Paul, MN (US)

(21) Appl. No.: 18/285,492

(22) PCT Filed: Apr. 4, 2022
(86) PCT No.: PCT/US2022/023372

§ 371 Date: Oct. 3, 2023

Related U.S. Application Data
(60) Provisional application No. 63/170,965, filed on Apr. 5, 2021.

(51) Int. Cl. A47J 37/07; A47J 37/04

(52) U.S. Cl. CPC A47J 37/0786; A47J 37/041; A47J 2037/0795

(57) ABSTRACT

A rotisserie device including a support ring for use in a partially opened hinged covered ceramic or metal grill or in a partially opened unhinged covered metal kettle charcoal grill having a front-mounted cover handle. The device has a generally wedge-shaped or trapezoidally-shaped external side profile that tapers from a maximum height nearest the handle to a minimum height furthest from the handle. The device includes at least one motor mounted outside the ring the drives a removable, rotatable rotisserie spit. The device facilitates rotisserie grilling of large meat cuts above accessories installed in the top of the grill base.

### CROSS REFERENCE TO RELATED APPLICATION

This application claims the benefit of U.S. Provisional Application No. 63/170,965, filed Apr. 5, 2021 and entitled “Kamado and Metal Kettle Rotisserie Adapter,” the disclosure of which is hereby incorporated by reference in its entirety.

### FIELD

This invention relates to rotisserie devices.

### BACKGROUND

Many outdoor cooks prefer to grill juicy or fatty foods using a rotisserie. The slowly-turning spit employed in such devices promotes a self-basting action that may provide more even cooking, may retain liquids in the food that might otherwise drip away, may reduce flare-ups and may provide more moist cooked foods.

Covered gas grills frequently are sold with or may be equipped with a rotisserie device. The device generally includes an electric reduction gear drive motor and a removable spit having a pointed rod fitted with two or more opposing tined, movable forks that secure the food in place during cooking. The motor and spit typically are mounted on short pedestals or other supports arranged so that the food will be centered over the grill cooking surface. The upper half in a covered gas grill (viz., a cover or lid joined by a hinge to the grill base) generally includes slots that fit over the spit when the rotisserie is in use and the grill cover is closed (viz., during cooking).

Covered porcelain steel kettle-style charcoal grills usually are not sold with a rotisserie device but may be equipped with an aftermarket rotisserie adapter. The adapter typically includes a fixed height cylindrical ring that fits atop the kettle base. The detachable grill cover is placed atop the ring during cooking and is lifted away to obtain access to the food. The ring typically includes a motor support on which an included electric reduction gear drive motor may be mounted, and slots to support an included removable spit with two or more opposing tined, movable forks.

Hinged, covered ceramic (viz., kamado) charcoal-burning grills have been used for many centuries. Until recently, most such grills were not sold with rotisserie capabilities. However, a wedge-shaped rotisserie adapter ring sold as the JoeTisserie™ adapter from Kamado Joe of Duluth, Georgia and shown in U.S. Pat. Nos. 9,603,484 B2 and 10,925,435 B2 has now become widely used in hinged, covered ceramic grills. As supplied, the JoeTisserie adapter is designed for the Kamado Joe 18 inch Classic series and 24 inch Big Joe™ series grills, but also fits similarly sized circular kamado grills from Big Green Egg and other suppliers of hinged, covered ceramic grills.

### SUMMARY

Whether used in the 18 inch or 24 inch diameter sizes, a JoeTisserie adapter can accommodate fairly large diameter meats or meat cuts (e.g., pork shoulder, pork rib roast, beef standing rib roast, leg of lamb, chicken, turkey and the like). However, the rotating meat travels down into and then out of the grill base, making it difficult to also place a heat deflector, drip pan, wire cooking grid or other accessory immediately beneath the adapter. By way of example, the recently-introduced SloRoller™ accessory from Kamado Joe includes a tapered insert section having a shaped sidewall and upper deflector plate as described in U.S. Patent Application Publication No. 2021/0068590 A1. The SloRoller accessory is said to promote a cyclonic airflow pattern and to increase the exposure of food cooked above the accessory to smoke particles. However, the upper deflector plate is approximately at the top of the grill base, at the level of the grill's “joinder seam” (viz., the parting plane or parting line defined by the mating surfaces of the grill base and cover when the cover is fully closed and in full normal contact with the base). Consequently the JoeTisserie adapter and the SloRoller accessory cannot be presently be used together to perform rotisserie grilling of large diameter meats, even though doing so might be desirable in order to obtain a more pronounced smoke flavor or smoke ring.

The present invention provides, in some embodiments, a rotisserie device comprising a support ring for use in a partially opened hinged covered ceramic or metal grill having a base and cover joined by the hinge and a cover handle opposite the hinge, or for use in a partially opened unhinged covered metal kettle charcoal grill having a front-mounted cover handle, the grill having a joinder seam defined by mating surfaces of the grill base and cover when the cover is fully closed and in full normal contact with the base, the device when installed in such a grill having a generally wedge-shaped or trapezoidally-shaped external side profile that tapers from a maximum ring height at a ring location nearest the handle to a minimum ring height at a ring location furthest from the handle and which holds the cover and base apart in a partially-opened position while inhibiting airflow into and out of the grill; the device comprising at least one motor mounted outside the ring that drives a removable, rotatable rotisserie spit that transects the ring on an axis closer to the handle than to the ring location opposite the handle, and wherein the spit has a greater swing radius (viz., one half the maximum diameter of meat that could be skewered on the spit and rotated without projecting below the joinder seam) and greater height with respect to the joinder seam and a lesser span across the ring (viz., the maximum axial length of meat that could be skewered on the spit and rotated without rubbing against the ring) compared to a spit that bisects the ring on an axis parallel to the handle. In these embodiments the frontwardly-displaced spit provides improved indirect grilling capability as well as a greater swing radius than a conventional spit that bisects the ring on an axis parallel to the handle. In some embodiments the spit is equipped with two or more adjustable inward-facing forks (e.g., for grilling roasts and whole fowl), and in some embodiments the spit is equipped with a basket (e.g., for grilling chicken wings, fish, fruits or vegetables).

The present invention provides, in additional embodiments, a rotisserie device comprising a support ring for use in a partially opened hinged covered ceramic or metal grill having a base and cover joined by the hinge and a cover handle opposite the hinge, or for use in a partially opened unhinged covered metal kettle charcoal grill having a front-mounted cover handle, wherein the grill has a joinder seam defined by mating surfaces of the grill base and cover when the cover is fully closed and in full normal contact with the base, the device when installed in such a grill having a generally wedge-shaped or trapezoidally-shaped external side profile that tapers from a maximum ring height at a ring location nearest the handle to a minimum ring height at a ring location furthest from the handle and holds the cover and base apart in a partially-opened position while inhibiting airflow into and out of the grill; the device comprising at least one motor mounted outside the ring that drives a removable, rotatable rotisserie spit that bisects or transects the ring, and wherein the spit has a swing radius with respect to the joinder seam of at least about 3½ inches (at least about 90 mm). In some embodiments, the spit has a swing radius of at least about 4 inches (at least about 100 mm) or at least about 5 inches (at least about 125 mm). The recited swing radii enable the device to be used for rotisserie grilling of meats having diameters of at least about 7 inches (at least about 180 mm), at least about 8 inches (at least about 200 mm) or at least about 10 inches (at least about 250 mm) while the device is located above (e.g., just above) a heat deflector, drip pan, wire cooking grid or other accessory installed at the top of the grill base and outside the swing radius.

In some embodiments the above-disclosed devices include a plurality of motors each driving a plurality of spits (e.g., two motors driving two spits or three motors driving three spits), with a spit nearest the handle having a greater height with respect to the joinder seam and a spit furthest from the handle having a lesser height with respect to the joinder seam and with at least one of such spits transecting the ring on an axis closer to the handle. In such embodiments the plurality of spits can provide increased cooking capacity compared to a single spit as well as adjustable height and consequent adjustable rotisserie grilling heat. In some embodiments one or more of the spits are equipped with adjustable inward-facing forks (e.g., for grilling roasts and whole fowl), and in some embodiments one or more of the spits are equipped with baskets.

The present invention provides, in additional embodiments, a hinged covered ceramic or metal kamado grill, or an unhinged covered metal kettle charcoal grill, the grill comprising a front-mounted cover handle and a joinder seam defined by mating surfaces of the grill base and cover when the cover is fully closed and in full normal contact with the base, and further comprising one of the above-disclosed rotisserie devices for installation between the grill base and cover and to support the cover in a partially opened position, and a heat deflector, drip pan, wire cooking grid or other accessory for installation at the top of the grill base below the disclosed device and outside the swing radius.

The present invention provides, in additional embodiments, a method for outdoor grilling, comprising in either order the steps of a) building a fire from combustible material in the base of a hinged covered ceramic or metal kamado grill, or in the base of an unhinged covered metal kettle charcoal grill, the grill comprising a front-mounted cover handle and a joinder seam defined by mating surfaces of the grill base and cover when the cover is fully closed and in full normal contact with the base, and b) opening the cover, installing in the grill one of the above-disclosed rotisserie devices, and reinstalling the cover to trap the device between the cover and base with the cover in a partially opened position.

The disclosed devices, grills and methods provide improved rotisserie cooking on hinged, covered kamado grills and unhinged covered metal kettle charcoal grills. The disclosed devices may be sold together with a new grill or as an aftermarket device for an existing grill.

### BRIEF DESCRIPTION OF THE DRAWING

FIG. 1 is a perspective view, partially in phantom, of an embodiment of the disclosed rotisserie device in use on a hinged, covered grill;

FIG. 2 is a perspective view, partially in phantom, of another embodiment of the disclosed rotisserie device in use on a hinged, covered grill;

FIG. 3 is a side view, partially in phantom, of another embodiment of the disclosed rotisserie device in use on a hinged, covered metal ketal grill equipped with a SloRoller accessory; and

FIG. 4 is a side view, partially in phantom, of another embodiment of the disclosed rotisserie device.

Like reference symbols in the various figures of the drawing indicate like elements. The elements in the drawing are not to scale.

### DETAILED DESCRIPTION

The recitation of a numerical range using endpoints includes all numbers subsumed within that range (e.g., 1 to 5 includes 1, 1.5, 2, 2.75, 3, 3.80, 4, 5, etc.).

The terms “a,” “an,” “the,” “at least one,” and “one or more” are used interchangeably. Thus, for example, a rotisserie spit that includes “a” tined fork means that the spit includes “one or more” tined forks.

The term “aperture” means a hole, slot or other opening.

The term “essentially the same” when used with respect to a numerical measure or quantity means within +10% and more preferably within +5% of that measure or quantity.

The term “grill” means a cooking device capable of a variety of cooking tasks including but not limited to grilling, baking, smoking and roasting.

The terms “half” and “halves” when used in reference to a covered grill are approximate, and need not represent a geometric one-half of the total shell surface in a covered grill. An individual half normally will be a lower surrounding shell that serves as a base and holds charcoal or other heat source, or an upper surrounding shell that serves as a cover.

Unless otherwise specified, the term “height” when used in respect to an element of the disclosed support ring refers to the length of a vertical line segment bisecting that element. In some specified contexts the terms “above”, “below” or “height” refer to the orientation of an element with respect to another element.

The term “inhibit airflow” when used in reference to the disclosed rotisserie device support ring means the ring will limit substantially or will prevent airflow into and out of a partially opened grill in which the support ring has been installed. The desired degree of airflow inhibition may vary, and desirably will be such as to permit extinguishment of burning coals in an otherwise closed grill due to combustion air starvation. Lesser degrees of airflow inhibition may be tolerated in some circumstances, for example airflow inhibition sufficient to discourage or prevent runaway temperature increases, or airflow inhibition sufficient to permit the temperature in a burning grill to be maintained at or below 149° C. (300° F.), 121° C. (250° F.) or 107° C. (225° F.) using the adjustable top and bottom dampers normally included with a hinged, covered charcoal-burning grill.

The term “joinder seam” when used in reference to a hinged or unhinged covered grill refers to the parting plane or parting line defined by the mating sealing surfaces of the grill base and cover when the cover is fully closed and its cover sealing surface is in full normal contact with the base sealing surface.

The terms “partially opened” and “partially uncovered” when used in reference to a covered grill, mean that the grill cover has been rotated away from the grill base (and for a hinged, covered grill, through a portion of but not through all of its hinged travel arc), so that the cover and base no longer contact one another through the full extent of their normal sealing surfaces. In such a position the cover and base sealing surfaces may however contact the installed rotisserie device. The terms “partially opened” and “partially uncovered” thus may refer to a covered grill either before or after installation of the disclosed rotisserie device support ring between the grill cover and grill base. These terms will be used whether or not other grill openings (such as the air intake vent normally provided in a grill base, or the combustion product exhaust vent normally provided in a grill cover) are fully or partially open or closed.

The term “ring” when used in reference to the disclosed rotisserie device support ring means a heat-resistant object having a generally open interior portion surrounded by a chock, wall or other grill-contacting portion that when viewed in cross-section from above its normal orientation during use has a continuous or nearly continuous rounded or at least partially rounded cross-sectional shape. Suitable ring shapes include circular shapes like those in the mating halves of a Kamado Joe or Big Green Egg grill, oval shapes like those in the mating halves of a Primo grill (from Primo Grills and Smokers of Tucker, Ga), flattened teardrop shapes like those in the mating halves of a Komodo Kamado OTB grill from Komodo Kamado of Bali, Indonesia (which, it may be noted, includes as supplied a small hole in the base which receives the motorized drive spindle of an accessory rotisserie device), and other functionally similar shapes.

The term “span” when used in reference to the disclosed rotisserie device support ring means the maximum axial length of meat that could be skewered on the spit and rotated without rubbing against the ring.

The term “swing radius” when used in reference to the disclosed rotisserie device support ring means one half the maximum diameter of meat that could be skewered on the spit and rotated without projecting below the joinder seam.

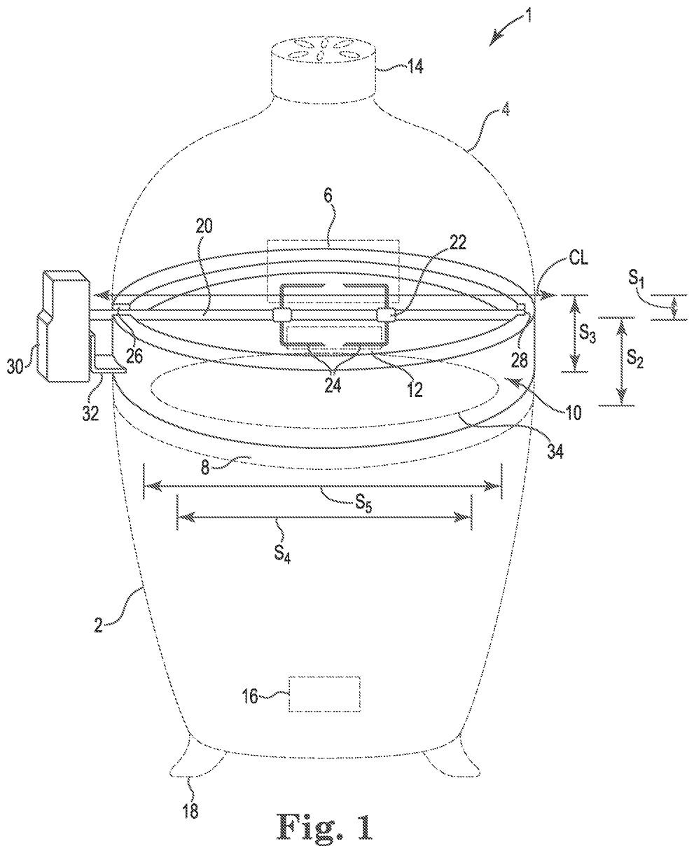

Turning now to FIG. 1, hinged, covered ceramic grill 1 is partly shown in phantom for clarity. Grill 1 is generally egg-shaped and includes lower approximate half or base 2, upper approximate half or cover 4, and fixed pivot hinge 6. Hinge 6 is affixed to clamping band 8 which surrounds base 2, and to a further clamping band, omitted in FIG. 1 for clarity, which surrounds cover 4. Base 2 and cover 4 have sealing surfaces that contact one another at a joinder seam when cover 4 is fully closed. Generally wedged-shaped rotisserie support ring 10 is positioned between base 2 and cover 4, and holds cover 4 in a partially-opened position. Handle 12 on the front of cover 4 permits cover 4 to be raised by rotating cover 4 away from base 2 in an arc around hinge 6. As shown, grill 1 also includes an adjustable top damper 14 and adjustable bottom damper 16, and rests on supporting feet 18. As will be understood by those skilled in the ceramic grill art, grill 1 may be supported in a variety of other devices including wheeled or stationary nests, tripods and supporting tables (not shown in FIG. 1).

For ease of reference in portions of the remaining description, clock numerals will sometimes be used to describe regions around the perimeter of the disclosed support rings when viewed from above. Clock position 12 will refer to the ring position nearest the hinge in a hinged, covered grill, and to the ring position furthest from the handle in such a grill or in an unhinged cover grill. Clock position 6 will refer to the ring position opposite from (viz., distal to) the hinge in a hinged, covered grill, and normally will be close to the cover handle in a hinged or unhinged covered grill. The disclosed support ring serves as a “chock” that holds the grill cover in a partially opened position, and is shortest (viz., has its least height or vertical thickness) at the 12 o'clock position and is tallest (viz., has its greatest height or vertical thickness) at the 6 o'clock position.

In the currently-sold version of the JoeTisserie support ring (not shown in FIG. 1), an electric motor is mounted on a bracket outside the ring at the 9 o'clock position. The motor drives a rotisserie spit that passes through the upper part of the ring at the 9 o'clock position, bisects the ring on an axis parallel to the hinge and handle, and terminates in a notch located in the ring inner sidewall at the 3 o'clock position. The axis on which such a spit would be located is designated by centerline CL in FIG. 1.

Support ring 10 in FIG. 1 includes a rotatable rotisserie spit 20 that transects but does not bisect ring 10. Spit 20 carries food-engaging forks 22 equipped with inwardly-facing tines 24. Spit 20 rides in and is supported by slot 26 and recess 28, and is rotatably driven by electric motor 30 mounted outside ring 10 on bracket 32. Motor 30 may be affixed to or rotatably fixed with respect to ring 10 using a variety of mounting devices (not shown in FIG. 1), including employing projecting tabs that slip between one or both of the lower or upper mating ring surfaces and the corresponding base or cover mating sealing surfaces, a mounting base secured to band 8 using fasteners or a magnetic clamp, or a mounting bracket permanently or removably affixed to one or more positions on ring 10. Motor 30 may be permanently or removably fixed to such a mounting device. Rotisserie gear reduction drive motors like those shown in FIG. 1 typically have a generally vertical orientation with a center of mass which in use lies below the central axis of spit 20. For mounting devices affixed to ring 10 or band 8, it may be desirable to rotate motor 30 so that its housing has a generally horizontal orientation. This will permit the housing to be rotationally affixed to ring 10 or band 8 at a greater lever arm distance from spit 20, thereby providing the motor mount with improved resistance to torque or shock loads caused by large or poorly-balanced rotating foods (e.g., turkeys). Base 2 may also be mounted in a table or nest configuration having a table top or other potentially interfering structure close to the joinder seam. In such cases motor 30 may need to be rotated or otherwise realigned or redesigned so that adequate clearance is maintained between the drive motor and table top or other structure. For example, the drive motor center of mass may need to be raised so that it lies at or above the central axis of spit 20. If the motor housing is rotated, normally downwardly-facing vents in the drive motor may need to be redesigned or relocated so that rain will not enter the drive motor in its new orientation.

Compared to the current JoeTisserie spit location discussed above, spit 20 is displaced towards the front of ring 10 by horizontal offset distance S₁. In a nominal 18 inch (460 mm) diameter grill, offset distance S₁ may for example be at least about 1 inch (25 mm), at least about 2 inches (at least about 50 mm), at least about 3 inches (at least about 75 mm), at least about 4 inches (at least about 100 mm) or at least about 5 inches (at least about 125 mm), with suitable adjustment of such offset distance for use in smaller or larger grills. Spit 20 is also located closer to the tallest portion of ring 10 near cover handle 12 and further from the shortest portion of ring 10 near hinge 6 than would be the case for a spit located along centerline CL. The frontward offset of spit 20 from centerline CL also makes it possible for spit 20 to be elevated so that is higher with respect to the grill joinder seam (indicated in FIG. 1 by distance S2) than would be the case (indicated in FIG. 1 by distance S3) for a spit located at centerline CL. Such upward and forward displacement facilitates indirect cooking, especially when doing so by building a sloping charcoal fire at the rear of a grill firebox. The upward displacement also increases the swing radius, thus facilitating rotisserie grilling of large cuts of meat above accessories (for example, deflector plate 34, shown in phantom) located within or on the grill base at heights or near the grill joinder seam. It should be noted that the forward displacement of spit 20 also reduces the spit length and the available span across ring 10, but the cooking benefits obtained by increasing the swing radius will in many cases outweigh the reduced meat length that may be required to accommodate a reduced span.

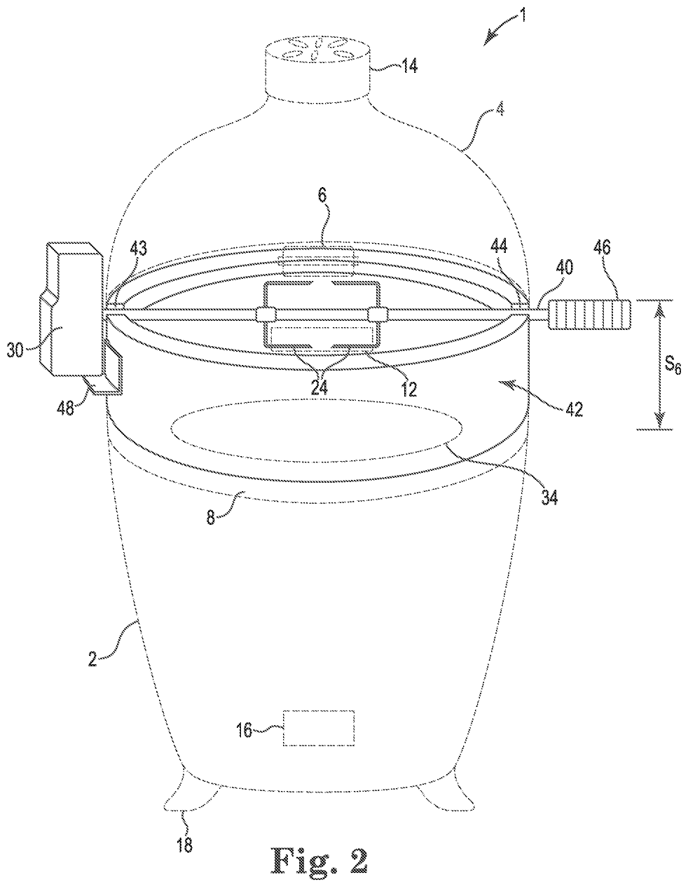

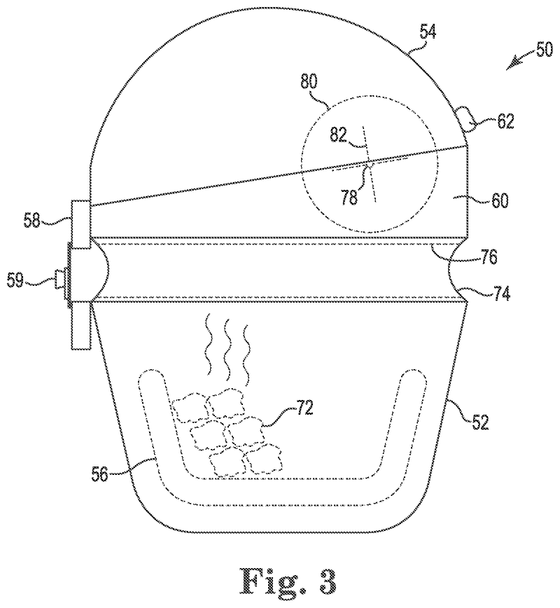

FIG. 2 illustrates ceramic grill 1 in which base 2, cover 4, band 8, damper 16 and feet 18 are as in FIG. 1, but in which ring 10 has been replaced by a taller or more sloped ring 42. Ring 42 includes a spit 40 that bisects ring 42 along centerline CL, and which rides in and is supported by slots 43 and 44. Handle 46 can be used to help install spit 40 in and remove spit 40 from ring 42. Spit 40 is rotatably driven by electric motor 30 supported on bracket 48. Compared to ring 10 in FIG. 1, the minimum height of ring 42 proximate hinge 6, or the taper of ring 42 when viewed in side profile, or both, have been increased so that height S6 of spit 40 above the joinder seam is at least about 3½ inches (at least about 90 mm). For a hinged covered grill, the extent to which the minimum ring height may be increased will be constrained somewhat by the hinge design and by the path the cover takes when opening and closing the cover. Increased minimum heights may however be accommodated by employing an adjustable height hinge like that discussed below in connection with FIG. 3.

FIG. 3 shows a side view of a Kettle Joe™ grill 50 from Kamado Joe of Duluth, Georgia. The Kettle Joe is a 22 inch kettle-style grill with a single layer porcelainized metal base 52 and cover 54, ceramic firebox 56 (shown in phantom), adjustable height cover hinge 58 equipped with a clamping screw 59 and handle 62. As depicted in FIG. 3, grill 50 includes a sloped indirect charcoal fire 72 (shown in phantom) positioned at the back of grill 50. Grill 50 has been modified by installing wedge-shaped rotisserie support ring 60 discussed in more detail below. Ring 60 is positioned atop removable center section smoke accessory 74. Accessory 74 is included with the Kettle Joe grill, and has a hyperboloid-shaped sidewall which according to its description in U.S. Patent Application Publication No. 2021/0068590 A1 can promote a cyclonic airflow pattern and increased smoke particle exposure for food cooked above deflector plate 76. When accessory 74 is not being used, hinge 58 can be lowered by removing a locking pin (not shown in FIG. 3), loosening clamping screw 59 and sliding the upper portion of hinge 58 downward towards base 52.

Support ring 60 is for clarity reasons shown in FIG. 3 without its accompanying drive motor, it being understood that such drive motor could be mounted on the left or right side of grill 50. Ring 60 includes forwardly-offset motor-driven spit 78 whose increased height above the joinder seam and above deflector plate 76 facilitate rotisserie grilling of larger diameter meats such as roast 80 (shown in phantom) carried on spit 78 and secured by two or more forks 82 (also shown in phantom).

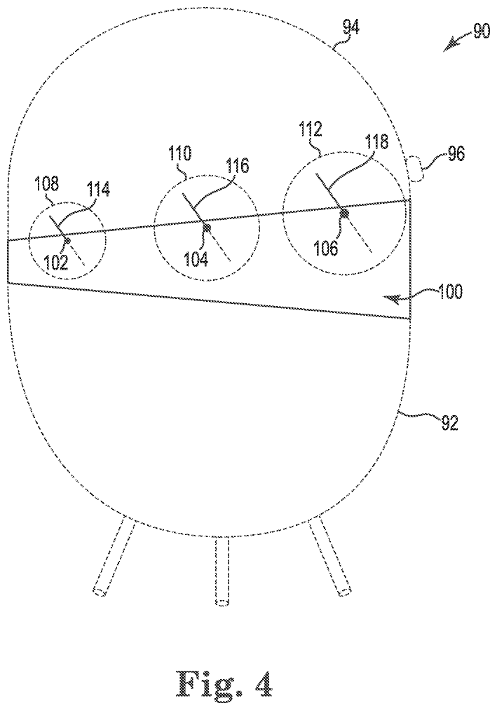

Referring next to FIG. 4, grill 90 is an unhinged kettle-style metal grill (for example, a 22 inch Weber Original Kettle Grill) having a base 92 and a removable cover 94 equipped with handle 96. Grill 90 has been modified by installing wedge-shaped rotisserie support ring 100 equipped with three motor driven spits 102, 104 and 106 having gradually increasing heights with respect to the joinder seam for spits located closest to handle 96. For clarity, spits 102, 104 and 106 are shown without their accompanying drive motors, it being understood that such drive motors could be mounted on the left, right or on alternating sides of grill 90. Spits 102, 104 and 106 respectively support meats 108, 110 and 112 (shown in phantom) which are each secured by two or more forks 114, 116 and 118 (partly shown in phantom). Meats 108, 110 and 112 may have the same or different diameters, and as depicted in FIG. 4 have a smaller diameter on spit 108 and a larger diameter on spit 112. Potential cooking time differences that may be caused by such different meat diameters may be addressed by banking the fire toward the front of base 92 or by inserting spits 106, 104 and 102 into ring 100 at different times during a cook.

If desired, upwardly-projecting inner tabs or an upwardly-projecting inner flange (not shown in FIG. 4) mat be added to the top of ring 100 so as to help discourage cover 94 from sliding off or otherwise becoming dislodged from support ring 100.

The disclosed support rings may be made from a variety of heat-resistant materials including metals such as formed or cast aluminum, steel or iron; heat-resistant ceramics; molded heat-resistant fibrous insulation materials; molded heat-resistant flexible materials such as silicone rubbers; Portland cement; concrete; combinations of the foregoing; and other materials that will be familiar to persons having ordinary skill in the barbeque grill art. Cast aluminum represents an especially desirable material. Exemplary steels include cold-rolled steel and stainless steel. Exemplary silicone rubbers include addition-cure, peroxide-cure and room-temperature vulcanizing (RTV) silicones. Exemplary ceramics include alumina, boron nitride, cordierite, mullite, silicon carbide, spinel, steatite, titanium carbide, Wollastonite, zirconia (including partially stabilized zirconia), glass-ceramics, porcelain, earthenware, reinforced ceramic composites and mixtures or combinations thereof. Foamed and other insulating ceramics may also be employed.

If made partly or entirely from metal, the disclosed support rings may be formed in a variety of ways including milling; cutting appropriately-tapered rings from cylindrical stock; casting; sintering; cutting or otherwise machining flat stock; or by rolling strips or other flat stock to form a ring perform and then welding, riveting or otherwise joining the preform ends to form a continuous ring. If made from a relatively brittle material such as a ceramic, then the disclosed support ring desirably will be formed using molding, sintering or casting and firing operations, and with adjustment of the ring dimensions as needed so as to avoid undue fragility at the 12 o'clock ring position or at the ring positions near the spit openings, slots or recesses. In such instance a greater partial cover opening may be desirable during use so as to provide sufficient thickness proximate the grill hinge. The ring may also or instead be strengthened using an inner or outer flanged ring, for example an inner flanged ring as shown in the above-mentioned U.S. Pat. Nos. 9,603,484 B2 and 10,925,435 B2.

The disclosed support rings may also include gaskets, seals or other materials to reduce air or smoke leakage between mating surfaces of the support ring and the grill base, cover or other adjacent accessories. A variety of high temperature-resistant materials may be employed, including NOMEX™ or KEVLAR™ aramid fibers, both from E.I. duPont de Nemours and Company; ULTRA TEMP™ alumina tape or cloth from Cotronics Corporation; molded, paper or textile high temperature products from Ibiden Co., Ltd.; GRAPHO-GLAS™ gasketing from Rutland Fire Clay Company; and other sealing substances that will be familiar to persons having ordinary skill in the barbecue grill art.

The dimensions and overall shape of the disclosed support ring may be adapted as need be to accommodate various grill models and sizes. For example, Kamado Joe ceramic grills are currently available with a circular cross-sectional shape at the joinder seam and nominal firebox widths of 34 cm (13.5 inches) for the Junior Series, 46 cm (18 inches) for the Classic Series and 61 cm (24 inches) for the Big Joe and Pro Joe Series grills. Big Green Egg grills are currently available with a circular cross-sectional shape at the joinder seam and nominal wire cooking grid diameters of 24 cm (9.5 inches) for the Mini grill, 33 cm (13 inches) for the Small grill, 38 cm (15 inches) for the Medium grill, 46 cm (18.25 inches) for the Large grill, 61 cm (24 inches) for the XL grill and 74 cm (29 inches) for the 2XL grill. The typical grill wall thickness at the mating sealing surfaces for these grills is about 25 cm (1 inch) in the case of a Kamado Joe Classic Series or Big Green Egg Large grill, and with similar, lesser or greater grill wall thicknesses for other size grills. Exemplary other grills that can be used with the disclosed adapter device include those shown in U.S. Pat. No. 3,276,440 (Sazegar) and U.S. Pat. No. 3,809,058 (Becker), in U.S. Published Patent Application Nos. US 2009/0308373 A1 (Scott et al.), US 2010/0095946A1 (Creel), US 2010/0258105 A1 (Simms, II) and US 2010/0258106 A1 (Simms, II); hinged covered grills from other suppliers including Bayou Classic, Big Steel Keg, Blaze, California Kamado, Char-Broil, Char-Griller, GourmetPot, Grill Dome, Imperial Kamado, Kamado Joe, Komodo Kamado, Meteor, Monolith Grill GmbH, Primo Grills and Smokers, Saffire, SnS Grills and Weber-Stephen Products; and unhinged covered metal kettle charcoal grills from Weber-Stephen Products, Char-Broil and many other suppliers.

The overall support ring shape need not be generally circular and may instead be oval, teardrop-shaped or otherwise shaped as needed to hold open the cover of the intended grill or grills. The extent to which the grill cover is partially opened during use of the support ring may for example be at least about 15, at least about 20, at least about 25, at least about 30, at least about 35 or at least about 40 degrees, and up to about 45, up to about 50, up to about 55 or up to about 60 degrees of upward cover rotation with respect to the joinder seam. The same angle ranges may be used to describe the angles defined by the respective cover-contacting and base-contacting surfaces of the support ring. The above dimensions and angles may be varied as needed for other ring materials, other grill models, other grill sizes, and to accommodate lesser or greater extents of partial cover opening during support ring installation and use. The support ring inside diameter may also be sized to permit or not permit wire cooking grid installation into and removal from the grill while the disclosed support ring is installed.

The disclosed support ring may also be modified to include handles, logos, warning legends, outer or inner coloration or dimpling or other surface modification.

Having thus described preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

1. A rotisserie device comprising a support ring for use in a partially opened hinged covered ceramic or metal grill having a base and cover joined by the hinge and a cover handle opposite the hinge, or for use in a partially opened unhinged covered metal kettle charcoal grill having a front-mounted cover handle, the grill having a joinder seam defined by mating surfaces of the grill base and cover when the cover is fully closed and in full normal contact with the base, the device when installed in such a grill having a generally wedge-shaped or trapezoidally-shaped external side profile that tapers from a maximum ring height at a ring location nearest the handle to a minimum ring height at a ring location furthest from the handle and which holds the cover and base apart in a partially-opened position while inhibiting airflow into and out of the grill; the device comprising at least one motor mounted outside the ring that drives a removable, rotatable rotisserie spit that transects the ring on an axis closer to the handle than to the ring location opposite the handle, and wherein the spit has a greater swing radius and greater height with respect to the joinder seam and a lesser span across the ring compared to a spit that bisects the ring on an axis parallel to the handle.

2-20. (canceled)

21. A rotisserie device according to claim 1, wherein the spit has a swing radius with respect to the joinder seam of at least about 3½ inches (at least about 90 mm).

22. A rotisserie device according to claim 1, wherein the spit has a swing radius of at least about 4 inches (at least about 100 mm).

23. A rotisserie device according to claim 1, wherein the spit has a swing radius of at least about 5 inches (at least about 125 mm).

24. A rotisserie device according to claim 1, wherein the spit has a swing radius that enables the device to be used for rotisserie grilling of meats having a diameter of at least about 7 inches (at least about 180 mm) while the device is located above a heat deflector, drip pan, wire cooking grid or other accessory installed at the top of the grill base and outside the swing radius.

25. A rotisserie device according to claim 1, wherein the device includes a plurality of motors each driving a plurality of spits, with a spit nearest the handle having a greater height with respect to the joinder seam and a spit furthest from the handle having a lesser height with respect to the joinder seam and with at least one of such spits transects the ring on an axis closer to the handle than to the ring location opposite the handle.

26. A rotisserie device according to claim 1, wherein the spit is equipped with two or more adjustable inward-facing forks.

27. A rotisserie device according to claim 1, wherein the spit is equipped with a basket.

28. A rotisserie device according to claim 1, wherein the support ring is made from cast aluminum.

29. A rotisserie device according to claim 1, wherein the device includes a high temperature-resistant gasket or seal that reduces air or smoke leakage between mating surfaces of the device and the grill base, cover or other adjacent accessories.

30. A rotisserie device according to claim 1, wherein during use of the device the grill cover is partially opened by at least about 15 degrees and up to about 60 degrees of upward cover rotation with respect to the joinder seam.

31. A rotisserie device according to claim 1, wherein during use of the device the grill cover is partially opened by at least about 20 degrees of upward cover rotation with respect to the joinder seam.

32. A rotisserie device according to claim 1, wherein during use of the device the grill cover is partially opened by at least about 25 degrees of upward cover rotation with respect to the joinder seam.

33. A hinged covered ceramic or metal kamado grill, or an unhinged covered metal kettle charcoal grill, the grill comprising a front-mounted cover handle and a joinder seam defined by mating surfaces of the grill base and cover when the cover is fully closed and in full normal contact with the base, and further comprising:
a) a rotisserie device comprising a support ring for use in such grill, the device when installed in such grill having a generally wedge-shaped or trapezoidally-shaped external side profile that tapers from a maximum ring height at a ring location nearest the handle to a minimum ring height at a ring location furthest from the handle and which holds the cover and base apart in a partially-opened position while inhibiting airflow into and out of the grill; the device comprising at least one motor mounted outside the ring that drives a removable, rotatable rotisserie spit that transects the ring on an axis closer to the handle than to the ring location opposite the handle, and wherein the spit has a greater swing radius and greater height with respect to the joinder seam and a lesser span across the ring compared to a spit that bisects the ring on an axis parallel to the handle, and
b) a heat deflector, drip pan, wire cooking grid or other accessory for installation at the top of the grill base below the disclosed device and outside the swing radius.

34. A grill according to claim 33, wherein the grill is a hinged covered ceramic kamado grill.

35. A grill according to claim 33, wherein the grill is a hinged covered metal kamado grill.

36. A grill according to claim 33, wherein the grill is an unhinged covered metal kettle charcoal grill.

37. A grill according to claim 33, wherein the accessory is a smoke deflector.

38. A grill according to claim 37, wherein the smoke deflector promotes a cyclonic airflow pattern and increased smoke particle exposure for food cooked above deflector.

39. A method for outdoor grilling, comprising the steps of:
a) building a fire from combustible material in the base of a hinged covered ceramic or metal kamado grill, or in the base of an unhinged covered metal kettle charcoal grill, the grill comprising a front-mounted cover handle and a joinder seam defined by mating surfaces of the grill base and cover when the cover is fully closed and in full normal contact with the base,
b) opening the cover and installing in the grill a rotisserie device comprising a support ring for use in such grill, the device when installed in such grill having a generally wedge-shaped or trapezoidally-shaped external side profile that tapers from a maximum ring height at a ring location nearest the handle to a minimum ring height at a ring location furthest from the handle and which holds the cover and base apart in a partially-opened position while inhibiting airflow into and out of the grill; the device comprising at least one motor mounted outside the ring that drives a removable, rotatable rotisserie spit that transects the ring on an axis closer to the handle than to the ring location opposite the handle; and wherein the spit has a greater swing radius and greater height with respect to the joinder seam and a lesser span across the ring compared to a spit that bisects the ring on an axis parallel to the handle, and
c) reinstalling the cover to trap the device between the cover and base with the cover in a partially opened position.
